(19) United States
(12) Patent Application Publication
(10) Pub. No.: US 2024/0394122 A1
(43) Pub. Date: Nov. 28, 2024

(54) INTERACTION EVENT RESPONSE METHOD AND APPARATUS, ELECTRONIC DEVICE AND STORAGE MEDIUM

(71) Applicant: Beijing Zitiao Network Technology Co., Ltd., Beijing (CN)

(72) Inventors: Xunpeng YIN, Beijing (CN); Weifeng HUANG, Beijing (CN); Ziyue WANG, Beijing (CN); Gao LIU, Beijing (CN); Yantong WEI, Beijing (CN)

(21) Appl. No.: 18/674,452

(22) Filed: May 24, 2024

(30) Foreign Application Priority Data
May 25, 2023 (CN) 202310604087.2

(51) Int. Cl. G06F 9/54

(52) U.S. Cl. CPC G06F 9/542

(57) ABSTRACT

The present disclosure provides an interaction event response method and apparatus, an electronic device and a storage medium. The method includes: displaying an event interaction module, the event interaction module includes at least one event interaction unit; acquiring a command attribute value corresponding to the event configuration command in response to an attribute value configuration triggering operation for an event configuration command in the event interaction unit; acquiring a unit data structure diagram corresponding to the event interaction unit based on the command attribute value corresponding to each event configuration command in each event interaction unit in response to an event execution triggering operation for the event interaction module; and generating a module data structure diagram corresponding to the event interaction module based on the unit data structure diagram, converting the module data structure diagram into an interaction response script, and executing the interaction response script.

### CROSS-REFERENCE TO RELATED APPLICATION

The present application claims priority of the Chinese Patent Application No. 202310604087.2, filed on May 25, 2023, the disclosure of which is incorporated herein by reference in the present application.

### TECHNICAL FIELD

Embodiments of the present disclosure relates to computer application technologies, and in particular to an interaction event response method and apparatus, an electronic device and a storage medium.

### BACKGROUND

With the development of computer application technologies, the variety and the quantity of application software are increased. Functions in single application software are becoming more and more abundant, among which there are some functions implemented through interaction operations.

The development of an interaction function in the application software usually requires professionals to write a corresponding program code according to an implementation logic of the interaction function. In this case, the code coupling degree is often high. When it is necessary to adjust and modify the interaction function, it is often necessary for professional and technical personnel to rewrite a program code corresponding to the interaction function, causing an adjustment way of the interaction function to be time-consuming and laborious, and a reuse rate of the code to be very low.

### SUMMARY

The present disclosure provides an interaction event response method and apparatus, an electronic device and a storage medium, which implement more flexible and convenient fine-grained configuration of a response logic for an event module, and automatically generate an interaction response script of the event module, so that the interaction response script can achieve the technical effects of high cohesion and low coupling.

In a first aspect, embodiments of the present disclosure provide an interaction event response method, which includes:
displaying an event interaction module, the event interaction module includes at least one event interaction unit, and the event interaction unit includes at least one event configuration command;
acquiring a command attribute value corresponding to the event configuration command in response to an attribute value configuration triggering operation for the event configuration command in the event interaction unit;
acquiring a unit data structure diagram corresponding to the event interaction unit based on the command attribute value corresponding to each event configuration command in each event interaction unit in response to an event execution triggering operation for the event interaction module; and
generating a module data structure diagram corresponding to the event interaction module based on the unit data structure diagram, converting the module data structure diagram into an interaction response script, and executing the interaction response script.

In a second aspect, embodiments of the present disclosure further provide an interaction event response apparatus, which includes:
an interaction-module display module, configured to display an event interaction module, the event interaction module includes at least one event interaction unit, and the event interaction unit includes at least one event configuration command;
an attribute value configuration module, configured to acquire a command attribute value corresponding to the event configuration command in response to an attribute value configuration triggering operation for the event configuration command in the event interaction unit;
an interaction-unit processing module, configured to acquire a unit data structure diagram corresponding to the event interaction unit based on the command attribute value corresponding to each event configuration command in each event interaction unit in response to an event execution triggering operation for the event interaction module; and
an interaction event response module, configured to generate a module data structure diagram corresponding to the event interaction module based on the unit data structure diagram, convert the module data structure diagram into an interaction response script, and execute the interaction response script.

In a third aspect, embodiments of the present disclosure further provide an electronic device, which includes:
one or more processors;
a storage apparatus, configured to store one or more programs,
the one or more programs, when executed by the one or more processors, cause the one or more processors to implement the interaction event response method as described in any one of the embodiments of the present disclosure.

In a fourth aspect, embodiments of the present disclosure further provide a storage medium including computer-executable instructions, the computer-executable instructions, when executed by a computer processor, are configured to implement the interaction event response method as described in any one of the embodiments of the present disclosure.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1 is a flow diagram of an interaction event response method provided by an embodiment of the present disclosure;

FIG. 2 is a flow diagram of another interaction event response method provided by an embodiment of the present disclosure;

FIG. 3 is a flow diagram of yet another interaction event response method provided by an embodiment of the present disclosure;

FIG. 4 is a flow diagram of an optional example of an interaction event response method provided by an embodiment of the present disclosure;

FIG. 5 shows a structural schematic diagram of an interaction event response apparatus provided by an embodiment of the present disclosure; and

FIG. 6 is a structural schematic diagram of an electronic device provided by an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units. Modifications of “one” and “more” mentioned in the present disclosure are schematic rather than restrictive, and those skilled in the art should understand that unless otherwise explicitly stated in the context, it should be understood as “one or more”.

The names of messages or information exchanged between multiple apparatuses in the embodiments of the present disclosure are only for illustrative purposes and are not used to limit the scope of the messages or information.

It can be understood that before using the technical solutions disclosed in various embodiments of the present disclosure, users should be informed of the types, use scope, use scenarios, etc. of personal information involved in the present disclosure in an appropriate way according to relevant laws and regulations and be authorized by the users.

For example, in response to receiving an active request from a user, prompt information is sent to the user to clearly prompt the user that an operation requested by the user to be performed is to require acquisition and use of personal information of the user. Therefore, the user can independently choose, according to the prompt information, whether to provide personal information to software or hardware such as an electronic device, an application program, a server or a storage medium that performs the operations of the technical solution of the present disclosure.

As an optional but non-limiting implementation, in response to receiving the active request of the user, the prompt information may be sent to the user by, for example, a pop-up window, in which the prompt information can be presented in the form of text. In addition, the pop-up window can also carry a selection control for the user to choose “agree” or “disagree” to provide personal information to the electronic device.

It can be understood that the above process of notifying and acquiring user authorization is only schematic, and does not limit the implementation of the present disclosure, and other ways meeting relevant laws and regulations can also be applied to the implementation of the present disclosure.

It can be understood that the data referred to in the present technical solution (including but not limited to the data itself, the acquisition or use of the data) should comply with the requirements of the applicable laws and related regulations.

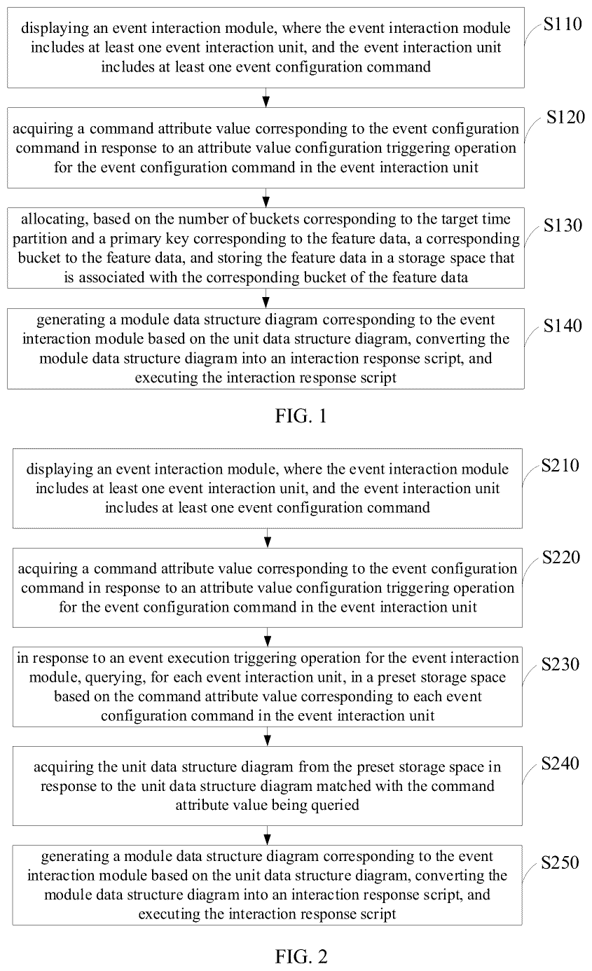

FIG. 1 is a flow diagram of an interaction event response method provided by an embodiment of the present disclosure. The embodiment of the present disclosure is applicable to a situation in which a response logic of an event interaction module is configured and an interaction response script for the event interaction module is automatically generated. This method may be executed by an interaction event response apparatus. The device may be implemented in the form of software and/or hardware, or optionally, by an electronic device which may be a mobile terminal, a PC terminal or a server.

As shown in FIG. 1, the method of this embodiment may specifically include:

S110: displaying an event interaction module, where the event interaction module includes at least one event interaction unit, and the event interaction unit includes at least one event configuration command.

The event interaction module can be understood as a module that can configure a target event in an interaction mode. In the embodiment of the present disclosure, the displaying the event interaction module may include: acquiring the event interaction module in response to an interaction triggering operation, and displaying the acquired event interaction module. In the embodiment of the present disclosure, there are various ways to acquire the event interaction module, which are not specifically limited here. For example, one way is to construct the event interaction module; another way is to display a default event interaction module; or yet another way is to acquire one event interaction module from constructed event interaction modules.

Exemplarily, the event interaction module may be a component or an region, displayed on a target function interface, on which all information of configuring the target event is displayed in a centralized manner.

In the embodiment of the present disclosure, the event interaction unit can be understood as a unit that can configure part of information of a target event in an interaction mode. The event interaction module may include one or more event interaction units, that is, the event interaction module may be obtained by combining one or more event interaction units. In a practical application, the event interaction module usually includes a plurality of event interaction units. The event interaction unit may include one or more event configuration commands, that is, the event interaction module may be configured by one or more event configuration commands. The event configuration command can be understood as a command that needs to configure an event.

Optionally, the event interaction unit may at least include an event triggering unit and an event execution unit. The event triggering unit can be understood as an interaction unit for configuring triggering conditions of the target event. The event execution unit can be understood as an interaction unit for configuring execution information of the target event. The execution information may include an execution object and an execution behavior. Accordingly, the event execution unit may include an event execution object command and an event execution behavior command. The event execution object can be understood as an execution object of the target event. The event execution behavior can be understood as a specific behavior of the event execution object.

In the embodiment of the present disclosure, a single event interaction unit can be independently configured by the event interaction module in a more convenient interaction mode, and the target event can be flexibly configured according to actual requirements. In the embodiment of the present disclosure, in a process of setting the event interaction module, a plurality of event interaction units can be combined; and/or the event configuration command in a single event interaction unit is configured, so that flexible configuration of different events may be implemented through the event interaction module.

S120: acquiring a command attribute value corresponding to the event configuration command in response to an attribute value configuration triggering operation for the event configuration command in the event interaction unit.

The attribute value configuration triggering operation can be understood as a triggering operation for configuring the attribute value of the event configuration command. The command attribute value can be understood as an attribute value configured for a parameter corresponding to the event configuration command. The correspondence between the event configuration command and the command attribute value can be one-to-one or one-to-many, and the correspondence can be configured according to actual requirements, which is not specifically limited here. Exemplarily, the command attribute value can be a specific triggering condition of the event triggering unit (such as clicking on a screen) or execution information of the event execution unit (such as one or more execution elements and/or execution animations corresponding to the execution elements). The execution information of the event execution unit may include object information of the event execution object or behavior information of the event execution behavior.

Specifically, a selection operation acting on the event configuration command in the event interaction unit is received, so that the selected event configuration command can be determined, and an attribute value configuration interface for the selected event configuration command is displayed. Further, the command attribute value for the selected event configuration command can be received based on the attribute value configuration interface. The attribute value configuration interface can be understood as an interface for configuring the command attribute value of the selected event configuration command.

As an optional implementation in the embodiment of the present disclosure, the receiving the command attribute value for the selected event configuration command based on the attribute value configuration interface may include: receiving the command attribute value for the selected event configuration command that is inputted based on the attribute value configuration interface, which can facilitate the user to configure a command attribute corresponding to the event configuration command according to an actual requirement, thus achieving a personalized configuration effect of the event configuration command.

As another optional implementation in the embodiment of the present disclosure, the receiving the command attribute value for the selected event configuration command based on the attribute value configuration interface may include: receiving a selection operation acting on at least one candidate attribute item in the attribute value configuration interface, and determining a selected candidate attribute item. Further, the attribute value corresponding to the selected candidate attribute item is taken as the command attribute value corresponding to the event configuration command.

The candidate attribute item can be understood as an attribute item which is pre-configured in the attribute value configuration interface for the user to select. In the embodiment of the present disclosure, the command attribute value is inputted for the event configuration command by selecting the candidate attribute item, so that the configuration of the command attribute value corresponding to the event configuration command is more convenient, thereby improving the user experience.

S130: acquiring a unit data structure diagram corresponding to the event interaction unit based on the command attribute value corresponding to each event configuration command in each event interaction unit in response to an event execution triggering operation for the event interaction module.

The event execution triggering operation can be understood as a triggering operation for controlling the execution of the event interaction module. The unit data structure diagram may be a data structure diagram constructed based on the command attribute value corresponding to each event configuration command in the event interaction unit.

Specifically, after the event execution triggering operation for the event interaction module is received, each event interaction unit included in the event interaction module is traversed. Furthermore, for each event interaction unit, each event configuration command included in the event interaction unit is traversed, which has the advantage that the information in the event interaction module is processed without omission, thus ensuring the integrity of the target event.

Specifically, a unit data structure diagram corresponding to each event interaction unit can be constructed based on the command attribute value corresponding to each event configuration command in each event interaction unit.

As an optional implementation in the embodiment of the present disclosure, acquiring the unit data structure diagram corresponding to each event interaction unit based on the command attribute value corresponding to each event configuration command in each event interaction unit may include: in response to the event configuration unit including one event configuration command, parsing the command attribute value corresponding to the event configuration command to obtain a command data structure diagram corresponding to the event configuration command, and taking the command data structure diagram as the unit data structure diagram corresponding to the event interaction unit. The command data structure diagram may be a data structure diagram obtained after parsing the command attribute value corresponding to the event configuration command.

Specifically, in response to the event configuration unit including one event configuration command, the command attribute value corresponding to the event configuration command can be parsed. Further, the command data structure diagram corresponding to the event configuration command may be obtained. After the command data structure diagram is obtained, the command data structure diagram can be used as the unit data structure diagram corresponding to the event interaction unit.

As an optional implementation in the embodiment of the present disclosure, parsing the command attribute value corresponding to the event configuration command to obtain a command data structure diagram corresponding to the event configuration command may include: parsing the command attribute value corresponding to the event configuration command, so as to obtain a parsing result; further, based on the parsing result, constructing the command data structure diagram corresponding to the event configuration command, thereby obtaining the command data structure diagram corresponding to the event configuration command.

As another optional implementation in the embodiment of the present disclosure, the parsing the command attribute value corresponding to the event configuration command to obtain a command data structure diagram corresponding to the event configuration command may include: querying in a storage space for storing a command data structure diagram based on the command attribute value corresponding to the event configuration command; acquiring the command data structure diagram from the storage space in response to the command data structure diagram matched with the command attribute value being queried, to reuse the existing command data structure diagram, thus avoiding repeated construction of the command structure diagram and achieving the technical effect of saving the storage space.

On the basis of the above embodiment, in response to the command data structure diagram matched with the command attribute value not being queried, the command attribute value corresponding to the event configuration command can be parsed, so that a parsing result can be obtained. Further, the command data structure diagram corresponding to the event configuration command can be constructed based on the parsing result.

As another optional implementation in the embodiment of the present disclosure, acquiring the unit data structure diagram corresponding to each event interaction unit based on the command attribute value corresponding to each event configuration command in each event interaction unit may include: in response to the event configuration unit including a plurality of event configuration commands, parsing, for each of the plurality of event configuration commands, the command attribute value corresponding to the event configuration command, so that the command data structure diagram corresponding to the event configuration command may be obtained. Further, a plurality of command data structure diagrams can be connected based on a logical relationship between the plurality of event configuration commands to obtain the unit data structure diagram corresponding to the event configuration unit.

In the embodiment of the present disclosure, the logical relationship between the plurality of event configuration commands can characterize a sequential execution order of the plurality of event configuration commands. Optionally, the logical relationship between the plurality of event configuration commands may include a parallel relationship and/or a progressive relationship. The parallel relationship can characterize that the plurality of event configuration commands are identical in importance. The progressive relationship can characterize the precedence of the plurality of event configuration commands.

As an optional implementation in the embodiment of the present disclosure, in response to the event configuration unit including a plurality of event configuration commands, for each of the plurality of event configuration commands, the command attribute value corresponding to the event configuration command can be parsed. Further, search can be conducted from the storage space for storing the command data structure diagram based on the command attribute value. In response to the command data structure diagram matched with the command attribute value being searched, the command data structure diagram can be read from the storage space by calling a predefined command data structure diagram reading method for reading the command data structure diagram. Further, the command data structure diagram can be acquired. By doing so, the advantage is that the command data structure diagram corresponding to the event configuration unit can be acquired quickly.

On the basis of the above embodiment, in response to the command data structure diagram matched with the command attribute value not being searched, the command attribute value corresponding to the event configuration command can be used as an actual parameter and transferred to a formal parameter of a diagram generation method predefined for generating the command data structure diagram; after parameter transfer is completed, the command data structure diagram corresponding to the event configuration command is constructed by executing the diagram generation method.

In the embodiment of the present disclosure, after the plurality of command data structure diagrams are obtained, the logical relationship between the plurality of event configuration commands is determined. Further, according to the logical relationship, the plurality of command data structure diagrams can be connected to obtain the unit data structure diagram corresponding to the event configuration unit.

In the embodiment of the present disclosure, parsing the command attribute value corresponding to the event configuration command to obtain the command data structure diagram corresponding to the event configuration command may include: parsing the command attribute value corresponding to the event configuration command to obtain at least one command function node corresponding to the event configuration command, and constructing the command data structure diagram corresponding to the event configuration command based on the command function node.

The command function node may be one or more function nodes obtained after parsing the command attribute value corresponding to the event configuration command. A number of command function nodes corresponding to different command attribute values may be the same or different. Generally, the number of command function nodes is associated with a command implementation logic corresponding to the command attribute value. The more complex the command implementation logic corresponding to the command attribute value, the greater the number of command function nodes corresponding to the command attribute value.

Specifically, by parsing the command attribute value corresponding to the event configuration command, a parsing result of the command attribute value corresponding to the event configuration command can be obtained. In a practical application, an event configuration command usually corresponds to one command attribute value. Further, the command function node corresponding to the event configuration command can be constructed according to the parsing result of the command attribute value. Further, the command data structure diagram corresponding to the event configuration command can be constructed based on the command function node.

In a technology of the above embodiment, after acquiring the unit data structure diagram corresponding to the event interaction unit, the embodiment of the present disclosure further includes: storing the command attribute value corresponding to the event configuration unit and the unit data structure diagram in a corresponding manner, which may facilitate the subsequent matching of the unit data structure diagram with the command attribute value corresponding to the event configuration unit from a plurality of unit data structure diagrams with the event configuration unit as a query condition.

S140: generating a module data structure diagram corresponding to the event interaction module based on the unit data structure diagram, converting the module data structure diagram into an interaction response script, and executing the interaction response script.

The module data structure diagram may be a data structure diagram generated based on the unit data structure diagram. The interaction response script may be a script obtained by converting the module data structure diagram into a script.

As an optional implementation in the embodiment of the present disclosure, in response to the number of unit data structure diagram being one, the unit data structure diagram is taken as a module data structure diagram corresponding to the event interaction module. Further, the module data structure diagram may be converted into an interaction response script by calling a script conversion method for converting the data structure diagram into a script, and the interaction response script is executed.

As another optional implementation in the embodiment of the present disclosure, in response to the number of unit data structure diagrams being multiple, the association relationship between the unit data structure diagrams may be determined. Further, the unit data structure diagrams may be connected based on the association relationship, so that a module data structure diagram corresponding to the event interaction module may be obtained. After the module data structure diagram is obtained, the module data structure diagram may be converted into an interaction response script and the interaction response script is executed.

On the basis of the above embodiment, after displaying the event interaction module, the embodiment of the present disclosure may further include: updating the event interaction module based on a unit editing triggering operation in response to the unit editing triggering operation for the event interaction unit, so as to implement flexible configuration of the event interaction module.

The unit editing triggering operation can be understood as a triggering operation for editing the event interaction unit. The unit editing triggering operation may include a unit adding triggering operation and/or a unit deleting triggering operation. The unit adding triggering operation can be understood as a triggering operation for newly adding a unit interaction unit in the event interaction module. The unit deleting triggering operation can be understood as a triggering operation for deleting the unit interaction unit in the event interaction module.

It should be noted that, in the embodiment of the present disclosure, the command attribute values set for command response objects in different event configuration commands may be the same. At this time, a pointer of the command attribute value may be pointed to the different event configuration commands, so that the different event configuration commands share the command attribute value, to implement the setting of diversified effects for the same command attribute value. It should also be noted that if an event configuration command is set with a plurality of command attribute values, the event configuration command may be taken as an independent event interaction unit. Or, in response to the plurality of event configuration commands being used to configure a same sub-event in the target event, the plurality of event configuration commands can be taken as an event interaction unit.

According to the technical solution of the embodiments of the present disclosure, fine-grained division of an event interaction module is implemented by displaying the event interaction module, where the event interaction module includes at least one event interaction unit, and the event interaction unit includes at least one event configuration command. By acquiring a command attribute value corresponding to the event configuration command in response to an attribute value configuration triggering operation for the event configuration command in the event interaction unit, independent configuration can be implemented for each event configuration command in each unit. By acquiring a unit data structure diagram corresponding to the event interaction unit based on the command attribute value corresponding to each event configuration command in each event interaction unit in response to an event execution triggering operation for the event interaction module, a coupling degree of the event interaction units in the event interaction module can be reduced. By generating a module data structure diagram corresponding to the event interaction module based on the unit data structure diagram, converting the module data structure diagram into an interaction response script, and executing the interaction response script, the triggering operation of the event interaction module can be automatically responded to. According to the technical solution of the embodiments of the present disclosure, more flexible and convenient fine-grained configuration of the response logic for the event module is implemented, so that the interaction response script of the event module can achieve the technical effects of high cohesion and low coupling.

FIG. 2 is a flow diagram of another interaction event response method provided by an embodiment of the present disclosure. On the basis of the above embodiment, a technical solution of the embodiment further refines how to acquire the unit data structure diagram corresponding to the event interaction unit. Optionally, acquiring the unit data structure diagram corresponding to the event interaction unit based on the command attribute value corresponding to each event configuration command in each event interaction unit in response to the event execution triggering operation for the event interaction module, includes: querying, for each event interaction unit, in a preset storage space based on the command attribute value corresponding to each event configuration command in the event interaction unit; and acquiring the unit data structure diagram from the preset storage space in response to the unit data structure diagram matched with the command attribute value being queried. See the description of the embodiment for specific implementations. The technical features the same as or similar to those of the previous embodiments are not described in detail here.

As shown in FIG. 2, the method of the embodiment may specifically include:

S210: displaying an event interaction module, where the event interaction module includes at least one event interaction unit, and the event interaction unit includes at least one event configuration command.

S220: acquiring a command attribute value corresponding to the event configuration command in response to an attribute value configuration triggering operation for the event configuration command in the event interaction unit.

S230: in response to an event execution triggering operation for the event interaction module, querying, for each event interaction unit, in a preset storage space based on the command attribute value corresponding to each event configuration command in the event interaction unit.

The preset storage space can be understood as a preset storage space for storing the unit data structure diagram. The preset storage space may include a cloud storage space and/or a local storage space.

Specifically, after the event execution triggering operation for the event interaction module is received, the event configuration command in the event interaction unit can be traversed for each event interaction unit, so that each event configuration command in the event interaction unit may be determined. Further, the consistency comparison may be performed between the command attribute value corresponding to each event configuration command and the command attribute value corresponding to the unit data structure diagram stored in the preset storage space.

S240: acquiring the unit data structure diagram from the preset storage space in response to the unit data structure diagram matched with the command attribute value being queried.

Specifically, in response to the unit data structure diagram matched with the command attribute value being queried, the unit data structure diagram may be read from the preset storage space, so that the unit data structure diagram may be acquired. In the embodiment of the present disclosure, acquiring the unit data structure diagram from the preset storage space may be performed by reusing the existing unit data structure diagram, so as to avoid reconstructing the unit data structure diagram, and achieve the technical effect of saving the storage space.

S250: generating a module data structure diagram corresponding to the event interaction module based on the unit data structure diagram, converting the module data structure diagram into an interaction response script, and executing the interaction response script.

In the technical solution of the embodiment of the present disclosure, after the event execution triggering operation for the event interaction module is received, for each event interaction unit, a query is made in the preset storage space based on the command attribute value corresponding to each event configuration command in the event interaction unit. In response to the unit data structure diagram matched with the command attribute value being queried, the unit data structure diagram is acquired from the preset storage space to achieve the reuse of the existing unit data structure diagram, so that repeated construction of the unit data structure diagram can be avoided, and the technical effects of saving time and space resources occupied by reconstructing the unit data structure diagram and improving the acquisition efficiency of the unit data structure diagram are achieved.

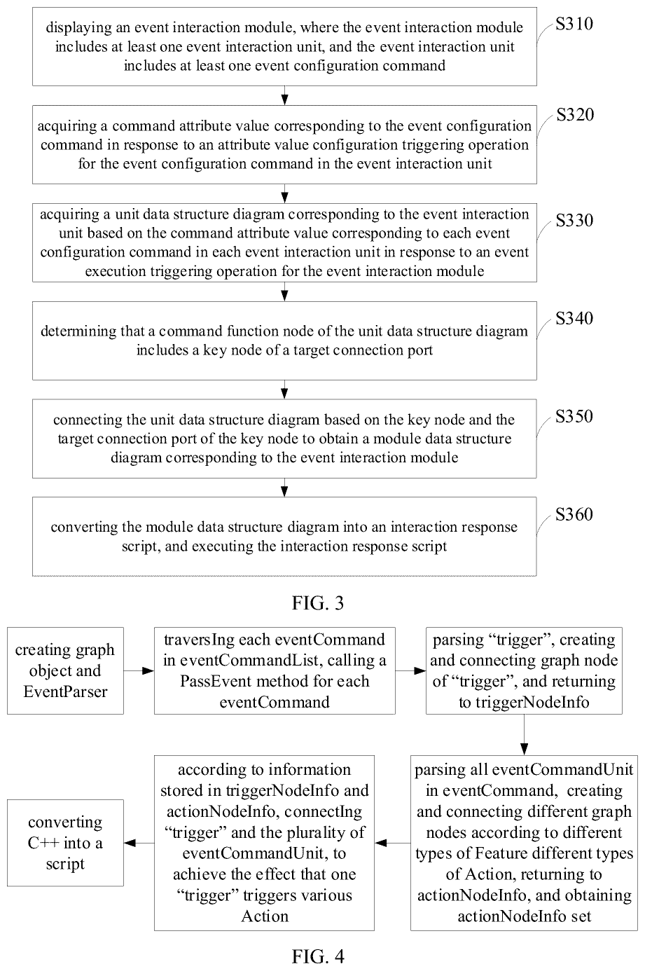

FIG. 3 is a flow diagram of yet another interaction event response method provided by an embodiment of the present disclosure. On the basis of the above embodiment, a technical solution of the embodiment further refines how to generate the module data structure diagram corresponding to the event interaction module based on the unit data structure diagram. Optionally, generating the module data structure diagram corresponding to the event interaction module based on the unit data structure diagram includes: determining that a command function node of the unit data structure diagram includes a key node of a target connection port, where the target connection port is a command output port and/or a command input port; and connecting the unit data structure diagram based on the key node and the target connection port of the key node to obtain a module data structure diagram corresponding to the event interaction module. See the description of the embodiment for specific implementations. The technical features the same as or similar to those of the previous embodiments are not described in detail here.

As shown in FIG. 3, the method of this embodiment may specifically include:

S310: displaying an event interaction module, where the event interaction module includes at least one event interaction unit, and the event interaction unit includes at least one event configuration command.

S320: acquiring a command attribute value corresponding to the event configuration command in response to an attribute value configuration triggering operation for the event configuration command in the event interaction unit.

S330: acquiring a unit data structure diagram corresponding to the event interaction unit based on the command attribute value corresponding to each event configuration command in each event interaction unit in response to an event execution triggering operation for the event interaction module.

S340: determining that a command function node of the unit data structure diagram includes a key node of a target connection port.

The key node can be understood as a command function node that needs to be connected in the unit data structure diagram. In other words, the key node may be a command function node including the target connection port.

In the embodiment of the present disclosure, one or more command function nodes may be included in a single unit data structure diagram. In response to one command function node being included in the unit data structure diagram, the command function node can be taken as a key node, and the target connection port of the key node is acquired. In response to a plurality of command function nodes being included in unit data structure diagram, the target connection port in the unit data structure diagram is determined, and the command function node including the target connection port is taken as the key node.

The target connection port can be understood as a port for connecting the unit data structure diagram. A model structure diagram may include a plurality of unit data structure diagrams, and connection positions of the unit data structure diagrams are also different, thus the target connection port can be a command output port and/or a command input port. The command output port can be understood as a port capable of outputting commands. The command input port can be understood as a port capable of receiving commands.

S350: connecting the unit data structure diagram based on the key node and the target connection port of the key node to obtain a module data structure diagram corresponding to the event interaction module.

Optionally, the logical relationship between the unit data structure diagrams is determined based on the logical relationship between the event interaction units, then a connection relationship between the key nodes is determined based on the connection relationship between the unit data structure diagrams, and finally, the unit data structure diagram is connected based on the connection relationship between the key nodes and based on the target connection port of the key node.

Specifically, in response to the number of unit data structure diagrams being multiple, one unit data structure diagram can be selected from the multiple unit data structure diagrams as a current unit data structure diagram. After the current unit data structure diagram is determined, a next unit data structure diagram matched with the target connection port can be selected from remaining unit data structure diagrams according to the target connection port of the key node in the current unit data structure diagram. Further, the current unit data structure diagram and the next unit data structure diagram can be connected based on the target connection port, the current unit data structure diagram is updated to the next unit data structure diagram; an operation of selecting the next unit data structure diagram matched with the target connection port from the remaining unit data structure diagrams according to the target connection port of the key node in the current unit data structure diagram is repeatedly executed; and the current unit data structure diagram and the next unit data structure diagram are connected based on the target connection port until the connection of all the unit data structure diagrams is completed. Further, the connected unit data structure diagram can be taken as the module data structure diagram corresponding to the event interaction module.

S360: converting the module data structure diagram into an interaction response script, and executing the interaction response script.

According to the technical solution of the embodiment of the present disclosure, by determining that the command function node of the unit data structure diagram includes the key node of the target connection port, the unit data structure diagram may be connected based on the key node and the target connection port of the key node to obtain the module data structure diagram corresponding to the event interaction module, so that the module data structure diagram can be constructed based on the unit data structure diagram, such that the technical effects of high cohesion for the single unit data structure diagram and low coupling for the multiple unit data result diagrams can be achieved, which facilitates the adjustment of subsequent module data structure diagrams.

As an optional example in the embodiment of the present disclosure, in the embodiment of the present disclosure, the event interaction module may be a unit that can configure part of information of effect events in an interaction mode. The event interaction module may include a plurality of event interaction units. In this example, the event interaction unit includes an event triggering unit and an event execution unit. The event triggering unit may be an interaction unit for configuring triggering conditions of an effect event. The event execution unit may be an interaction unit for configuring execution information of the effect event. The event execution unit may include a command to configure an event execution object and a command to configure an event execution behavior. In this example, taking the execution object as an effect element and the execution behavior as an animation effect of the effect element as an example, as shown in FIG. 4, the interaction event response method in the embodiment of the present disclosure can specifically include the following steps:

1. A graph object and an event parser object (EventParser) are created in advance. The graph object can be understood as an object used to logically connect effect events, and the event parser object can be understood as an object for parsing effect events.

2. Each effect event command (eventCommand) in an effect event command list (eventCommandList) is traversed through the event parser object, and for each effect event command, the effect event command is parsed by calling a PassEvent method.

3. After the effect event command is parsed, a command attribute value and effect triggering condition “trigger” in the effect event command can be determined. Then, the effect triggering condition is parsed, and in a parsing process, a graph node triggered by the effect is created.

In response to the number of graph node triggered by the effect being one, the graph node is taken as a key node triggered by the effect; in response to the number of graph nodes triggered by the effect being multiple, according to a triggering logic triggered by the effect, the graph nodes are connected and key nodes of the graph nodes including ports are determined, the key nodes including the ports can be used to connect with other key nodes. After the key nodes are determined, a set of node information and port information of the key nodes triggered by the effect can be obtained and recorded in triggerNodeInfo, and returned to triggerNodeInfo.

4. After effect triggering is parsed, all effect event command units (eventCommandUnit) in the effect event command corresponding to the effect triggering can be parsed. In the parsing process, for each effect event command unit, different graph nodes of the effect event command unit can be created and connected according to the types of “Feature” of the effect elements configured in the effect event command unit and the types of animation effects “Action” of the effect elements.

In response to the number of graph node of the effect event command unit being one, the graph node is taken as the key node of the effect event command unit; in response to the number of graph nodes of the effect event command unit being multiple, according to the animation logic of the effect, the graph nodes are connected, and the key nodes of the graph nodes including the ports are determined. After the key nodes are determined, the set of node information and port information of the key nodes of the effect event command unit can be obtained and recorded in actionNodeInfo, and returned to an actionNodeInfo set.

5. According to the set of node information and port information of the key nodes stored in triggerNodeInfo and actionNodeInfo, the key nodes of the effect triggering condition “trigger” and the key nodes of the plurality of eventCommandUnit corresponding to the effect triggering are connected, so as to achieve the effect that one “trigger” triggers various “Action”.

6. After the key nodes are connected, a connection result can be obtained. After the connection result is obtained, the connection result can be converted into a script based on the graph object of C++ (C++ in FIG. 4 is converted into a script), and the script is executed.

On the basis of the above embodiments, in order to enrich an animation effect of one effect element, in the embodiment of the present disclosure, different effect event commands can hold the same effect element, that is, the number of pointers of one effect element may be multiple, and the pointers point to different effect event command units, respectively. For example, the effect element may be a map. A triggering condition for displaying the map on the screen may be single-clicking or double-clicking the screen. Then, two effect event commands may be configured. The effect event command may be a command for configuring the animation effect of the effect element. Effect triggering in one effect event command may be single-clicking the screen, the effect element may be the map, and the animation effect of the effect element may be displaying the map. Effect triggering in the other effect event command may be double-clicking the screen, the effect element may be the map, and the animation effect of the effect element may be displaying the map. At this point, pointers of the map point to the two configured effect event commands, respectively.

In order to enrich the diversity of effect animations, in the embodiment of the present disclosure, different effect event commands can set different animation effects for the same effect element, thus achieving the superposition of at least two animation effects of one effect element. In the above example, the effect element is a map, and the animation effect of the map may be that the map moves in a certain direction and flashes in the moving process. Then, in the embodiment of the present disclosure, two effect event commands may be configured, where one effect event command may be configured with a map moving in a certain direction, and the other effect event command may be configured with a map flashing in a moving process.

On the basis of the above embodiments, one configured effect event command may be modified, so that a user can set effects according to an actual situation, thus achieving a customized setting effect of effects.

According to the technical solution of the embodiment of the present disclosure, more flexible and convenient fine-grained configuration of a response logic for an effect event is implemented, the customization requirements of effects can be met, and the configured implementation logic is consistent with an underlying graph logic, which is convenient for the iteration of subsequent effect codes.

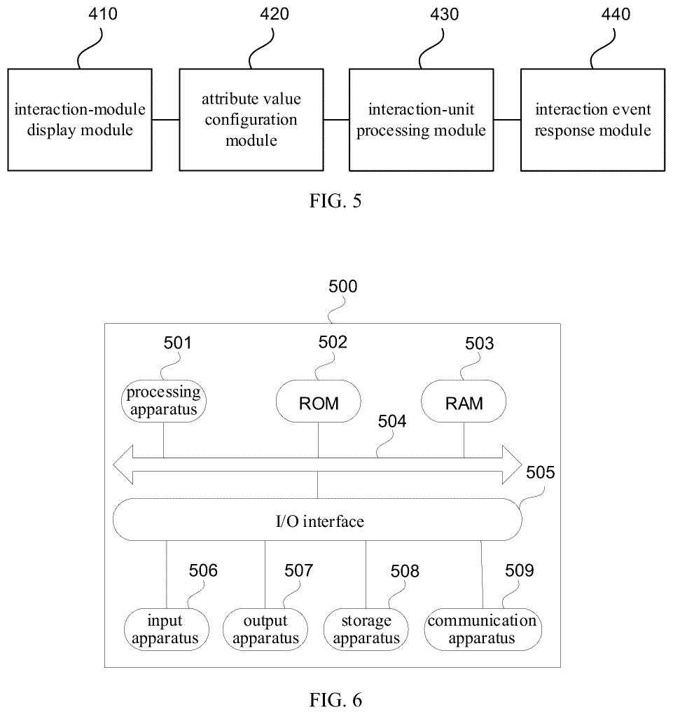

FIG. 5 shows a structural schematic diagram of an interaction event response apparatus provided by an embodiment of the present disclosure. As shown in FIG. 5, the apparatus includes: an interaction-module display module 410, an attribute value configuration module 420, an interaction-unit processing module 430 and an interaction event response module 440.

The interaction-module display module 410 is configured to display an event interaction module, where the event interaction module includes at least one event interaction unit, and the event interaction unit includes at least one event configuration command;

the attribute value configuration module 420 is configured to acquire a command attribute value corresponding to the event configuration command in response to an attribute value configuration triggering operation for the event configuration command in the event interaction unit;

the interaction unit processing module 430 is configured to acquire a unit data structure diagram corresponding to the event interaction unit based on the command attribute value corresponding to each event configuration command in each event interaction unit in response to an event execution triggering operation for the event interaction module; and

the interaction event response module 440 is configured to generate a module data structure diagram corresponding to the event interaction module based on the unit data structure diagram, convert the module data structure diagram into an interaction response script, and execute the interaction response script.

According to the technical solution of the embodiments of the present disclosure, fine-grained division of an event interaction module is implemented by displaying the event interaction module, where the event interaction module includes at least one event interaction unit, and the event interaction unit includes at least one event configuration command. By acquiring a command attribute value corresponding to the event configuration command in response to an attribute value configuration triggering operation for the event configuration command in the event interaction unit, independent configuration can be implemented for each event configuration command in each unit. By acquiring a unit data structure diagram corresponding to the event interaction unit based on the command attribute value corresponding to each event configuration command in each event interaction unit in response to an event execution triggering operation for the event interaction module, a coupling degree of the event interaction units in the event interaction module can be reduced. By generating a module data structure diagram corresponding to the event interaction module based on the unit data structure diagram, converting the module data structure diagram into an interaction response script, and executing the interaction response script, the triggering operation of the event interaction module can be automatically responded to. According to the technical solution of the embodiments of the present disclosure, more flexible and convenient fine-grained configuration of the response logic for the event module is implemented, so that the interaction response script of the event module can achieve the technical effects of high cohesion and low coupling.

Optionally, the interaction-unit processing module 430 is configured to:
in response to the event configuration unit including one event configuration command, parse the command attribute value corresponding to the event configuration command to obtain a command data structure diagram corresponding to the event configuration command, and take the command data structure diagram as the unit data structure diagram corresponding to the event interaction unit.

Optionally, the interaction-unit processing module 430 is configured to:
in response to the event configuration unit including a plurality of event configuration commands, parse, for each of the plurality of event configuration commands, the command attribute value corresponding to the event configuration command to obtain a command data structure diagram corresponding to the event configuration command; and
connect a plurality of command data structure diagrams based on a logical relationship between the plurality of event configuration commands to obtain the unit data structure diagram corresponding to the event configuration unit.

Optionally, the interaction-unit processing module 430 is configured to:
parse the command attribute value corresponding to the event configuration command to obtain at least one command function node corresponding to the event configuration command, and construct a command data structure diagram corresponding to the event configuration command based on the command function node.

Optionally, the apparatus further includes a data storage module, and the data storage module is configured to:
store, after the unit data structure diagram corresponding to the event interaction unit is acquired, the command attribute value corresponding to the event configuration unit and the unit data structure diagram in a corresponding manner.

Optionally, the interaction-unit processing module 430 is configured to:
query, for each event interaction unit, in a preset storage space based on the command attribute value corresponding to each event configuration command in the event interaction unit; and
acquire the unit data structure diagram from the preset storage space in response to the unit data structure diagram matched with the command attribute value being queried.

Optionally, the interaction event response module 440 is configured to:
determine that a command function node of the unit data structure diagram includes a key node of a target connection port, where the target connection port is a command output port and/or a command input port; and
connect the unit data structure diagram based on the key node and the target connection port of the key node to obtain a module data structure diagram corresponding to the event interaction module.

Optionally, the apparatus further includes an interaction-unit editing module, and the interaction-unit editing module is configured to:
update, after the event interaction module is displayed, the event interaction module based on a unit editing triggering operation in response to the unit editing triggering operation for the event interaction unit, where the unit editing triggering operation includes a unit adding triggering operation and/or a unit deleting triggering operation.

Optionally, the event interaction unit at least includes an event triggering unit and an event execution unit, and the event execution unit includes an event execution object command and an event execution behavior command.

The interaction event response apparatus provided by the embodiment of the present disclosure can execute the interaction event response method provided by any of embodiments of the present disclosure, and has corresponding functional modules and beneficial effects for executing the method.

It is worth noting that the various units and modules included in the above apparatus are only divided according to functional logics, but not limited thereto, as long as the corresponding functions can be implemented; in addition, the specific names of the functional units are only for the convenience of distinguishing between each other, and are not used to limit the protection scope of the disclosed embodiments.

FIG. 6 is a structural schematic diagram of an electronic device provided by an embodiment of the present disclosure. Referring to FIG. 6, FIG. 6 illustrates a schematic structural diagram of an electronic device 600 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 6 is merely an example, and should not pose any limitation to the functions and the range of use of the embodiments of the present disclosure.

As illustrated in FIG. 6, the electronic device 500 may include a processing apparatus 501 (e.g., a central processing unit, a graphics processing unit, etc.), which can perform various suitable actions and processing according to a program stored in a read-only memory (ROM) 502 or a program loaded from a storage apparatus 508 into a random-access memory (RAM) 503. The RAM 503 further stores various programs and data required for operations of the electronic device 500. The processing apparatus 501, the ROM 502, and the RAM 503 are interconnected by means of a bus 504. An input/output (I/O) interface 505 is also connected to the bus 504.

Usually, the following apparatus may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a loudspeaker, a vibrator, or the like; a storage apparatus 508 including, for example, a magnetic tape, a hard disk, or the like; and a communication apparatus 509. The communication apparatus 509 may allow the electronic device 500 to be in wireless or wired communication with other devices to exchange data. While FIG. 6 illustrates the electronic device 500 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 509 and installed, or may be installed from the storage apparatus 508, or may be installed from the ROM 502. When the computer program is executed by the processing apparatus 501, the above-mentioned functions defined in the methods of some embodiments of the present disclosure are performed.

The names of messages or information exchanged between multiple apparatuses in the embodiments of the present disclosure are only for illustrative purposes and are not used to limit the scope of the messages or information.

The electronic device provided by this embodiment of the present disclosure and the interaction event response method provided by the above embodiments belong to the same inventive concept. Technical details that are not described in detail in this embodiment can be referred to the above embodiments, and this embodiment has the same beneficial effects as the above embodiments.

Embodiments of the present disclosure provide a computer storage medium on which a computer program is stored, the program, when executed by a processor, implements the interactive event response method provided in the above embodiments.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: display an event interaction module, the event interaction module includes at least one event interaction unit, and the event interaction unit includes at least one event configuration command;
acquire a command attribute value corresponding to the event configuration command in response to an attribute value configuration triggering operation for the event configuration command in the event interaction unit;
acquire a unit data structure diagram corresponding to the event interaction unit based on the command attribute value corresponding to each event configuration command in each event interaction unit in response to an event execution triggering operation for the event interaction module; and
generate a module data structure diagram corresponding to the event interaction module based on the unit data structure diagram, convert the module data structure diagram into an interaction response script, and execute the interaction response script.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, [Example 1] provides an interaction event response method, which includes:
displaying an event interaction module, the event interaction module includes at least one event interaction unit, and the event interaction unit includes at least one event configuration command;
acquiring a command attribute value corresponding to the event configuration command in response to an attribute value configuration triggering operation for the event configuration command in the event interaction unit;
acquiring a unit data structure diagram corresponding to the event interaction unit based on the command attribute value corresponding to each event configuration command in each event interaction unit in response to an event execution triggering operation for the event interaction module; and
generating a module data structure diagram corresponding to the event interaction module based on the unit data structure diagram, converting the module data structure diagram into an interaction response script, and executing the interaction response script.

According to one or more embodiments of the present disclosure, [Example 2] provides an interaction event response method, which includes:
in some alternative implementations, acquiring the unit data structure diagram corresponding to the event interaction unit based on the command attribute value corresponding to each event configuration command in each event interaction unit in response to the event execution triggering operation for the event interaction module, includes:
in response to the event configuration unit including one event configuration command, parsing the command attribute value corresponding to the event configuration command to obtain a command data structure diagram corresponding to the event configuration command, and taking the command data structure diagram as the unit data structure diagram corresponding to the event interaction unit.

According to one or more embodiments of the present disclosure, [Example 3] provides an interaction event response method, which includes:
in some alternative implementations, acquiring the unit data structure diagram corresponding to the event interaction unit based on the command attribute value corresponding to each event configuration command in each event interaction unit in response to the event execution triggering operation for the event interaction module, includes:
in response to the event configuration unit including a plurality of event configuration commands, parsing, for each of the plurality of event configuration commands, the command attribute value corresponding to the event configuration command to obtain a command data structure diagram corresponding to the event configuration command; and
connecting a plurality of command data structure diagrams based on a logical relationship between the plurality of event configuration commands to obtain the unit data structure diagram corresponding to the event configuration unit.

According to one or more embodiments of the present disclosure, [Example 4] provides an interaction event response method, which includes:
in some alternative implementations, parsing the command attribute value corresponding to the event configuration command to obtain the command data structure diagram corresponding to the event configuration command, includes:
parsing the command attribute value corresponding to the event configuration command to obtain at least one command interaction event node corresponding to the event configuration command, and constructing the command data structure diagram corresponding to the event configuration command based on the command interaction event node.

According to one or more embodiments of the present disclosure, [Example 5] provides an interaction event response method, which includes:
in some alternative implementations, after acquiring the unit data structure diagram corresponding to the event interaction unit, the interaction event response method further includes:
storing the command attribute value corresponding to the event configuration unit and the unit data structure diagram in a corresponding manner.

According to one or more embodiments of the present disclosure, [Example 6] provides an interaction event response method, which includes:
in some alternative implementations, acquiring the unit data structure diagram corresponding to the event interaction unit based on the command attribute value corresponding to each event configuration command in each event interaction unit in response to the event execution triggering operation for the event interaction module, includes:
querying, for each event interaction unit, in a preset storage space based on the command attribute value corresponding to each event configuration command in the event interaction unit; and
acquiring the unit data structure diagram from the preset storage space in response to the unit data structure diagram matched with the command attribute value being queried.

According to one or more embodiments of the present disclosure, [Example 7] provides an interaction event response method, which includes:
in some alternative implementations, generating the module data structure diagram corresponding to the event interaction module based on the unit data structure diagram, includes:
determining that a command interaction event node of the unit data structure diagram includes a key node of a target connection port, the target connection port is a command output port and/or a command input port; and
connecting the unit data structure diagram based on the key node and the target connection port of the key node to obtain a module data structure diagram corresponding to the event interaction module.

According to one or more embodiments of the present disclosure, [Example 8] provides an interaction event response method, which includes:
in some alternative implementations, after displaying the event interaction module, the interaction event response method further includes:
updating the event interaction module based on a unit editing triggering operation in response to the unit editing triggering operation for the event interaction unit, the unit editing triggering operation includes a unit adding triggering operation and/or a unit deleting triggering operation.

According to one or more embodiments of the present disclosure, [Example 9] provides an interaction event response method, which includes:
in some alternative implementations, the event interaction unit at least includes an event triggering unit and an event execution unit, and the event execution unit includes an event execution object command and an event execution behavior command.

According to one or more embodiments of the present disclosure, [Example 10] provides an interaction event response apparatus, which includes:
an interaction-module display module, configured to display an event interaction module, the event interaction module includes at least one event interaction unit, and the event interaction unit includes at least one event configuration command;
an attribute value configuration module, configured to acquire a command attribute value corresponding to the event configuration command in response to an attribute value configuration triggering operation for the event configuration command in the event interaction unit;
an interaction-unit processing module, configured to acquire a unit data structure diagram corresponding to the event interaction unit based on the command attribute value corresponding to each event configuration command in each event interaction unit in response to an event execution triggering operation for the event interaction module; and
an interaction event response module, configured to generate a module data structure diagram corresponding to the event interaction module based on the unit data structure diagram, convert the module data structure diagram into an interaction response script, and execute the interaction response script.

According to one or more embodiments of the present disclosure, [Example 11] provides an interaction event response apparatus, which includes:
in some alternative implementations, the interaction-unit processing module is configured to:
in response to the event configuration unit including one event configuration command, parse the command attribute value corresponding to the event configuration command to obtain a command data structure diagram corresponding to the event configuration command, and take the command data structure diagram as the unit data structure diagram corresponding to the event interaction unit.

According to one or more embodiments of the present disclosure, [Example 12] provides an interaction event response apparatus, which includes:
in some alternative implementations, the interaction-unit processing module is configured to:
in response to the event configuration unit including a plurality of event configuration commands, parse, for each of the plurality of event configuration commands, the command attribute value corresponding to the event configuration command to obtain a command data structure diagram corresponding to the event configuration command; and
connect a plurality of command data structure diagrams based on a logical relationship between the plurality of event configuration commands to obtain the unit data structure diagram corresponding to the event configuration unit.

According to one or more embodiments of the present disclosure, [Example 13] provides an interaction event response apparatus, which includes:
in some alternative implementations, the interaction-unit processing module 430 is configured to:
parse the command attribute value corresponding to the event configuration command to obtain at least one command function node corresponding to the event configuration command, and construct a command data structure diagram corresponding to the event configuration command based on the command function node.

According to one or more embodiments of the present disclosure, [Example 14] provides an interaction event response apparatus, the apparatus further includes a data storage module;
in some alternative implementations, the data storage module is configured to:
store, after the unit data structure diagram corresponding to the event interaction unit is acquired, the command attribute value corresponding to the event configuration unit and the unit data structure diagram in a corresponding manner.

According to one or more embodiments of the present disclosure, [Example 15] provides an interaction event response apparatus, which includes:
in some alternative implementations, the interaction-unit processing module 430 is configured to:
query, for each event interaction unit, in a preset storage space based on the command attribute value corresponding to each event configuration command in the event interaction unit; and
acquire the unit data structure diagram from the preset storage space in response to the unit data structure diagram matched with the command attribute value being queried.

According to one or more embodiments of the present disclosure, [Example 16] provides an interaction event response apparatus, which includes:
in some alternative implementations, the interaction event response module 440 is configured to:
determine that a command function node of the unit data structure diagram includes a key node of a target connection port, where the target connection port is a command output port and/or a command input port; and
connect the unit data structure diagram based on the key node and the target connection port of the key node to obtain a module data structure diagram corresponding to the event interaction module.

According to one or more embodiments of the present disclosure, [Example 17] provides an interaction event response apparatus, the apparatus further includes an interaction-unit editing module;
in some alternative implementations, the interaction-unit editing module is configured to:
update, after the event interaction module is displayed, the event interaction module based on a unit editing triggering operation in response to the unit editing triggering operation for the event interaction unit, where the unit editing triggering operation includes a unit adding triggering operation and/or a unit deleting triggering operation.

According to one or more embodiments of the present disclosure, [Example 18] provides an interaction event response apparatus, which includes:
in some alternative implementations, the event interaction unit at least includes an event triggering unit and an event execution unit, and the event execution unit includes an event execution object command and an event execution behavior command.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims. Specific manners of operations performed by the modules in the apparatus in the above embodiment have been described in detail in the embodiments regarding the method, which will not be explained and described in detail herein again.

1. An interaction event response method, comprising:
displaying an event interaction module, wherein the event interaction module comprises at least one event interaction unit, and the event interaction unit comprises at least one event configuration command;
acquiring a command attribute value corresponding to the event configuration command in response to an attribute value configuration triggering operation for the event configuration command in the event interaction unit;
acquiring a unit data structure diagram corresponding to the event interaction unit based on the command attribute value corresponding to each event configuration command in each event interaction unit in response to an event execution triggering operation for the event interaction module; and
generating a module data structure diagram corresponding to the event interaction module based on the unit data structure diagram, converting the module data structure diagram into an interaction response script, and executing the interaction response script.

2. The interaction event response method according to claim 1, wherein acquiring the unit data structure diagram corresponding to the event interaction unit based on the command attribute value corresponding to each event configuration command in each event interaction unit in response to the event execution triggering operation for the event interaction module, comprises:
in response to the event configuration unit comprising one event configuration command, parsing the command attribute value corresponding to the event configuration command to obtain a command data structure diagram corresponding to the event configuration command, and taking the command data structure diagram as the unit data structure diagram corresponding to the event interaction unit.

3. The interaction event response method according to claim 1, wherein acquiring the unit data structure diagram corresponding to the event interaction unit based on the command attribute value corresponding to each event configuration command in each event interaction unit in response to the event execution triggering operation for the event interaction module, comprises:
in response to the event configuration unit comprising a plurality of event configuration commands, parsing, for each of the plurality of event configuration commands, the command attribute value corresponding to the event configuration command to obtain a command data structure diagram corresponding to the event configuration command; and
connecting a plurality of command data structure diagrams based on a logical relationship between the plurality of event configuration commands to obtain the unit data structure diagram corresponding to the event configuration unit.

4. The interaction event response method according to claim 2, wherein parsing the command attribute value corresponding to the event configuration command to obtain the command data structure diagram corresponding to the event configuration command, comprises:
parsing the command attribute value corresponding to the event configuration command to obtain at least one command interaction event node corresponding to the event configuration command, and constructing the command data structure diagram corresponding to the event configuration command based on the command interaction event node.

5. The interaction event response method according to claim 3, wherein parsing the command attribute value corresponding to the event configuration command to obtain the command data structure diagram corresponding to the event configuration command, comprises:
parsing the command attribute value corresponding to the event configuration command to obtain at least one command interaction event node corresponding to the event configuration command, and constructing the command data structure diagram corresponding to the event configuration command based on the command interaction event node.

6. The interaction event response method according to claim 1, wherein after acquiring the unit data structure diagram corresponding to the event interaction unit, the interaction event response method further comprises:
storing the command attribute value corresponding to the event configuration unit and the unit data structure diagram in a corresponding manner.

7. The interaction event response method according to claim 1, wherein acquiring the unit data structure diagram corresponding to the event interaction unit based on the command attribute value corresponding to each event configuration command in each event interaction unit in response to the event execution triggering operation for the event interaction module, comprises:
querying, for each event interaction unit, in a preset storage space based on the command attribute value corresponding to each event configuration command in the event interaction unit; and
acquiring the unit data structure diagram from the preset storage space in response to the unit data structure diagram matched with the command attribute value being queried.

8. The interaction event response method according to claim 1, wherein generating the module data structure diagram corresponding to the event interaction module based on the unit data structure diagram, comprises:
determining that a command interaction event node of the unit data structure diagram comprises a key node of a target connection port, wherein the target connection port is a command output port and/or a command input port; and
connecting the unit data structure diagram based on the key node and the target connection port of the key node to obtain a module data structure diagram corresponding to the event interaction module.

9. The interaction event response method according to claim 1, wherein after displaying the event interaction module, the interaction event response method further comprises:
updating the event interaction module based on a unit editing triggering operation in response to the unit editing triggering operation for the event interaction unit, wherein the unit editing triggering operation comprises a unit adding triggering operation and/or a unit deleting triggering operation.

10. The interaction event response method according to claim 1, wherein the event interaction unit at least comprises an event triggering unit and an event execution unit, and the event execution unit comprises an event execution object command and an event execution behavior command.

11. An interaction event response apparatus, comprising:
an interaction-module display module, configured to display an event interaction module, wherein the event interaction module comprises at least one event interaction unit, and the event interaction unit comprises at least one event configuration command;
an attribute value configuration module, configured to acquire a command attribute value corresponding to the event configuration command in response to an attribute value configuration triggering operation for the event configuration command in the event interaction unit;
an interaction-unit processing module, configured to acquire a unit data structure diagram corresponding to the event interaction unit based on the command attribute value corresponding to each event configuration command in each event interaction unit in response to an event execution triggering operation for the event interaction module; and
an interaction event response module, configured to generate a module data structure diagram corresponding to the event interaction module based on the unit data structure diagram, convert the module data structure diagram into an interaction response script, and execute the interaction response script.

12. An electronic device, comprising:
one or more processors;
a storage apparatus, configured to store one or more programs,
wherein the one or more programs, when executed by the one or more processors, cause the one or more processors to implement:
displaying an event interaction module, wherein the event interaction module comprises at least one event interaction unit, and the event interaction unit comprises at least one event configuration command;
acquiring a command attribute value corresponding to the event configuration command in response to an attribute value configuration triggering operation for the event configuration command in the event interaction unit;
acquiring a unit data structure diagram corresponding to the event interaction unit based on the command attribute value corresponding to each event configuration command in each event interaction unit in response to an event execution triggering operation for the event interaction module; and
generating a module data structure diagram corresponding to the event interaction module based on the unit data structure diagram, converting the module data structure diagram into an interaction response script, and executing the interaction response script.

13. The electronic device according to claim 12, wherein acquiring the unit data structure diagram corresponding to the event interaction unit based on the command attribute value corresponding to each event configuration command in each event interaction unit in response to the event execution triggering operation for the event interaction module, comprises:
in response to the event configuration unit comprising one event configuration command, parsing the command attribute value corresponding to the event configuration command to obtain a command data structure diagram corresponding to the event configuration command, and taking the command data structure diagram as the unit data structure diagram corresponding to the event interaction unit.

14. The electronic device according to claim 12, wherein acquiring the unit data structure diagram corresponding to the event interaction unit based on the command attribute value corresponding to each event configuration command in each event interaction unit in response to the event execution triggering operation for the event interaction module, comprises:
in response to the event configuration unit comprising a plurality of event configuration commands, parsing, for each of the plurality of event configuration commands, the command attribute value corresponding to the event configuration command to obtain a command data structure diagram corresponding to the event configuration command; and
connecting a plurality of command data structure diagrams based on a logical relationship between the plurality of event configuration commands to obtain the unit data structure diagram corresponding to the event configuration unit.

15. The electronic device according to claim 12, wherein after acquiring the unit data structure diagram corresponding to the event interaction unit, the one or more programs further cause the one or more processors to implement:
storing the command attribute value corresponding to the event configuration unit and the unit data structure diagram in a corresponding manner.

16. The electronic device according to claim 12, wherein acquiring the unit data structure diagram corresponding to the event interaction unit based on the command attribute value corresponding to each event configuration command in each event interaction unit in response to the event execution triggering operation for the event interaction module, comprises:
querying, for each event interaction unit, in a preset storage space based on the command attribute value corresponding to each event configuration command in the event interaction unit; and
acquiring the unit data structure diagram from the preset storage space in response to the unit data structure diagram matched with the command attribute value being queried.

17. The electronic device according to claim 12, wherein generating the module data structure diagram corresponding to the event interaction module based on the unit data structure diagram, comprises:
determining that a command interaction event node of the unit data structure diagram comprises a key node of a target connection port, wherein the target connection port is a command output port and/or a command input port; and
connecting the unit data structure diagram based on the key node and the target connection port of the key node to obtain a module data structure diagram corresponding to the event interaction module.

18. The electronic device according to claim 12, wherein after displaying the event interaction module, the one or more programs further cause the one or more processors to implement:
updating the event interaction module based on a unit editing triggering operation in response to the unit editing triggering operation for the event interaction unit, wherein the unit editing triggering operation comprises a unit adding triggering operation and/or a unit deleting triggering operation.

19. The electronic device according to claim 12, wherein the event interaction unit at least comprises an event triggering unit and an event execution unit, and the event execution unit comprises an event execution object command and an event execution behavior command.

20. A storage medium comprising computer-executable instructions, wherein the computer-executable instructions, when executed by a computer processor, are configured to implement the interaction event response method according to claim 1.
